(19) United States
(12) Patent Application Publication
(10) Pub. No.: US 2012/0240898 A1
(43) Pub. Date: Sep. 27, 2012

(54) INTEGRATED PLASTIC THROTTLE BODY, ELECTRONIC CONTROL UNIT, AND SENSORS FOR SMALL ENGINE

(75) Inventors: Myron Lemecha, Dearborn, MI (US); Diane Marie Gietzen-Jett, Warren, MI (US); Thomas Edward Brefeld, Dearborn, MI (US); Robert Edward Belke, West Bloomfield, MI (US); Gary Spring, Lingfield (GB); Terry Joyce, Belfast (GB)

(73) Assignee: VISTEON GLOBAL TECHNOLOGIES, INC., Van Buren Twp., MI (US)

(21) Appl. No.: 13/069,910

(22) Filed: Mar. 23, 2011

(51) Int. Cl. F02D 41/00

(52) U.S. Cl. 123/350

(57) ABSTRACT

An electronic control assembly for a throttle body includes a lower housing portion having a plurality of apertures formed therethrough, a circuit board disposed adjacent at least a portion of the lower housing portion, a pressure sensor disposed adjacent the lower housing portion and electrically coupled to the circuit board, wherein a sensing portion of the pressure sensor extends into a first one of the apertures formed in the lower housing portion, a temperature sensor disposed adjacent the lower housing portion and electrically coupled to the circuit board, wherein a sensing portion of the temperature sensor extends into a second one of the apertures formed in the lower housing portion, and an upper housing portion coupled to the throttle body and cooperating with the lower housing portion to substantially enclose the circuit board, the pressure sensor, and the temperature sensor.

### FIELD OF THE INVENTION

The present invention relates generally to an electronic control unit for a throttle body of an engine. In particular, the invention is directed to a throttle body assembly including an integrated electronic control unit and a mechanical throttle body.

### BACKGROUND OF THE INVENTION

Typically, an electronic fuel injection system, EFI, of an internal combustion engine has an air throttle body for controlling the amount of air flowing through an engine head intake valve and into a combustion chamber of the engine. At least one fuel injector of the EFI injects fuel directly into the air throttle body, or alternatively, into the piston cylinder to mix with the incoming air flowing through the throttle body. A spark plug or ignition system then ignites the resultant fuel-and-air mixture within the combustion chamber. The operation and sequential timing of each one of these components is dictated by a variety of engine operating parameters. Accordingly, various sensors are required to provide input signal into an electronic control unit, ECU, of the EFI system for processing in accordance with software instructions of a microprocessor of the ECU, which then provides output signals to perform numerous functions.

The sensors typically include an air temperature sensor, an engine speed sensor, an engine temperature sensor, a pressure sensor, an air mass flow rate sensor, and a throttle position sensor, all disposed at various locations around the engine. The sensors provide input signals to the ECU which in turn provides output signals which control numerous drivers or power transistors of various components of the EFI system such as fuel injectors, an ignition coil, and a fuel pump. The power transistors, when energized by the output signals of the microprocessor, generate heat, and thus, must be cooled and/or remotely located to avoid damaging the microprocessor.

Manufacturing of known EFI systems is complex, and requires various wiring harnesses, connectors and associated support structures routed or located about the engine to the appropriate sensors and components generally scattered throughout the engine vicinity. The overall system is thus bulky or cumbersome and generally hampers engine maintenance and increases cost. Moreover, excessive electrical connections located about the engine can lead to continuity and system failures caused by debris contamination. Poor heat management can also be damaging to electronic components such as the microprocessor or printed circuit boards of the ECU. Thus, the ECU typically is located some distance away from the heat dissipating engine and the drivers spaced considerably away from the microprocessor. This contributes toward poor packaging of the engine, EFI system components, and/or the entire product application.

Furthermore, the existing engine control system for a small engine is too costly for use in emerging markets. Individually packaged components do not make efficient use of design space and often result in complex and limited service access.

It would be desirable to develop a throttle body assembly that integrates an electronic control unit, a plurality of sensors, and a throttle body to reduce package space, manufacturing costs, and manufacturing leads times, while allowing an independent servicing of the electronic control unit and the throttle body.

### SUMMARY OF THE INVENTION

Concordant and consistent with the present invention, a throttle body assembly that integrates an electronic control unit, a plurality of sensors, and a throttle body to reduce package space, manufacturing costs, and manufacturing leads times, while allowing an independent servicing of the electronic control unit and the throttle body, has surprisingly been discovered.

In one embodiment, an electronic control assembly for a throttle body comprises: a lower housing portion having a plurality of apertures formed therethrough; a circuit board disposed adjacent at least a portion of the lower housing portion; a pressure sensor disposed adjacent the lower housing portion and electrically coupled to the circuit board, wherein a sensing portion of the pressure sensor extends into a first one of the apertures formed in the lower housing portion; a temperature sensor disposed adjacent the lower housing portion and electrically coupled to the circuit board, wherein a sensing portion of the temperature sensor extends into a second one of the apertures formed in the lower housing portion; and an upper housing portion coupled to the throttle body and cooperating with the lower housing portion to substantially enclose the circuit board, the pressure sensor, and the temperature sensor.

In another embodiment, a throttle body assembly comprises: a mechanical throttle body including a throttle valve disposed in a passage formed through the throttle body, wherein the throttle body includes a plurality of first apertures formed in a wall defining the passage; a heatsink disposed adjacent a surface of the throttle body, the heatsink including a plurality of second apertures formed therethrough, wherein each of the second apertures is substantially aligned with one of the first apertures formed in the wall of the throttle body; a circuit board disposed adjacent at least a portion of the heatsink; a pressure sensor disposed adjacent the heatsink and electrically coupled to the circuit board, wherein a sensing portion of the pressure sensor extends into a first one of the second apertures formed in the heatsink to sense a pressure in the passage of the throttle body; a temperature sensor disposed adjacent the heatsink and electrically coupled to the circuit board, wherein a sensing portion of the temperature sensor extends into a second one of the second apertures formed in the heatsink to sense a temperature in the passage of the throttle body; and a housing portion coupled to the throttle body and cooperating with the heat sink to substantially enclose the circuit board, wherein the housing portion secures the heatsink in a substantially static position relative to the throttle body.

In yet another embodiment, a throttle body assembly comprising:

a mechanical throttle body including a first passage formed therethrough along a first axis of the throttle body and a second passage formed therethrough along a second axis, wherein the throttle body includes a plurality of sensor apertures formed in a wall defining the first passage; a throttle valve disposed in the first passage formed through the throttle body; a shaft disposed in the second passage formed through the throttle body, the shaft coupled to the throttle valve, wherein an actuation of the shaft controls a position of the throttle valve and a flow of fluid through the first passage of the throttle body; a lower housing portion disposed adjacent a surface of the throttle body, the lower housing portion including a plurality of second apertures formed therethrough, wherein each of the second apertures is substantially aligned with one of the first apertures formed in the wall of the throttle body; a circuit board disposed adjacent at least a portion of the lower housing portion; a pressure sensor disposed adjacent the lower housing portion and electrically coupled to the circuit board, wherein a sensing portion of the pressure sensor extends into a first one of the second apertures formed in the lower housing portion to sense a pressure in the passage of the throttle body; a temperature sensor disposed adjacent the lower housing portion and electrically coupled to the circuit board, wherein a sensing portion of the temperature sensor extends into a second one of the second apertures formed in the lower housing portion to sense a temperature in the passage of the throttle body; and an upper housing portion coupled to the throttle body and cooperating with the lower housing portion to substantially enclose the circuit board, wherein the upper housing portion secures the lower housing portion in a substantially static position relative to the throttle body.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a partially exploded front perspective view of a throttle body assembly according to an embodiment of the present invention;

FIG. 2 is a partially exploded bottom rear perspective view of the throttle body assembly of FIG. 1 with a portion of an electronic control unit cut away;

FIG. 3 is a partially exploded top rear perspective view of the throttle body assembly of FIG. 1 with a portion of the electronic control unit cut away;

FIG. 4 is a bottom perspective view of a portion of the electronic control unit of the throttle body assembly of FIG. 1 with a portion of the electronic control unit shown cut away;

FIG. 5 is a bottom front perspective view of the throttle body assembly of FIG. 1;

FIG. 6 is a cross-sectional view of the throttle body assembly of FIG. 5 taken along line 6-6;

FIG. 7A is a partially exploded top perspective view of a throttle bracket of the throttle body assembly of FIG. 1;

FIG. 7B is a side elevational view of the throttle bracket of FIG. 7A;

FIG. 8A is a partially exploded top perspective view of a throttle bracket according to another embodiment of the present invention; and

FIG. 8B is a side elevational view of the throttle bracket of FIG. 8A.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

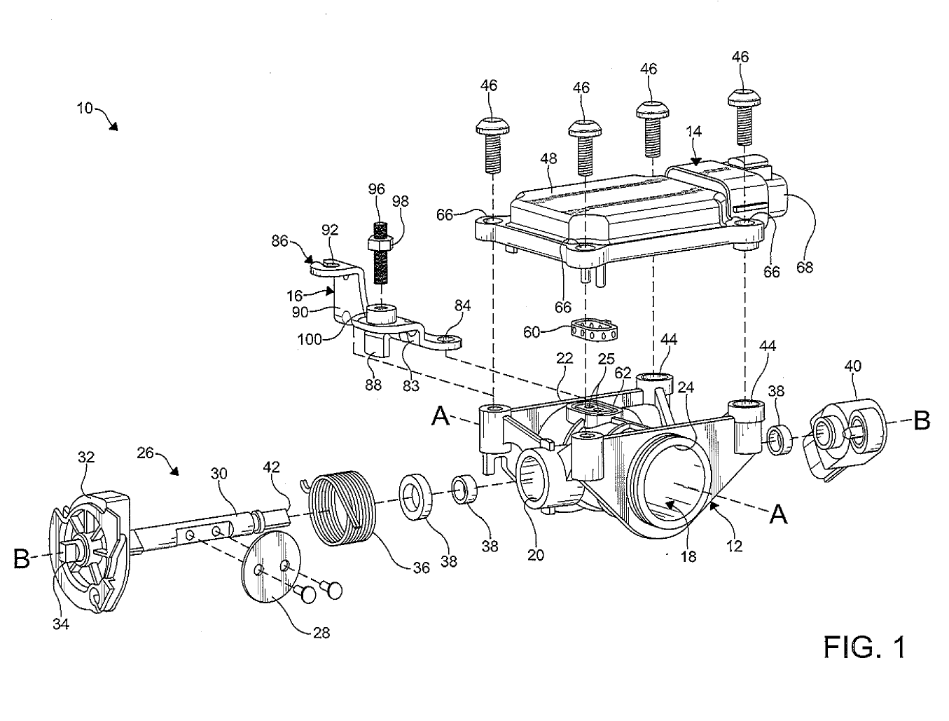

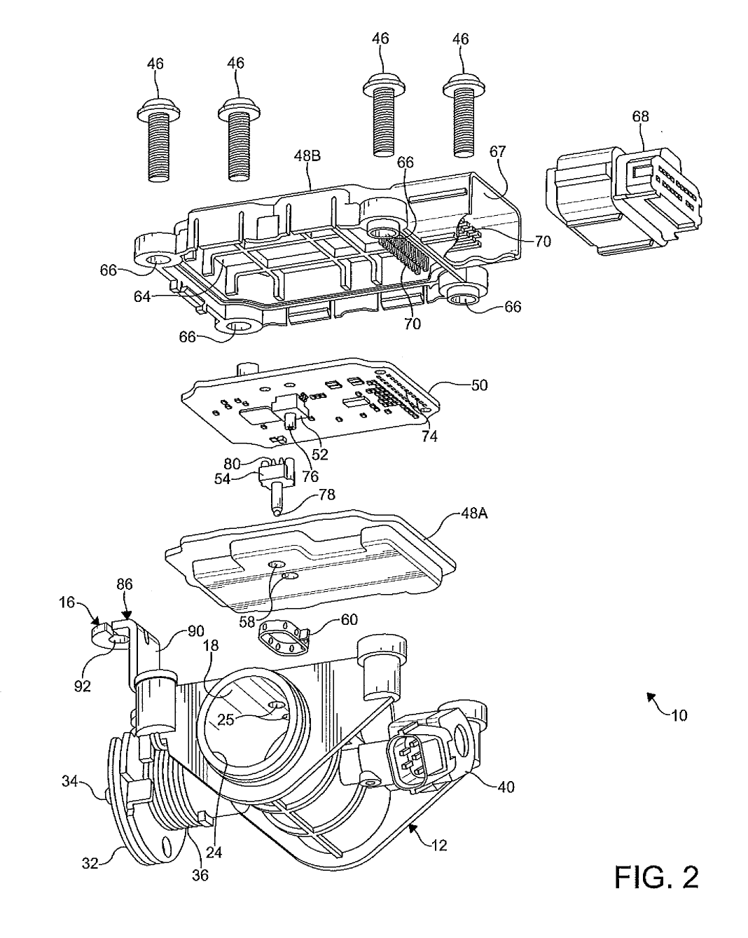

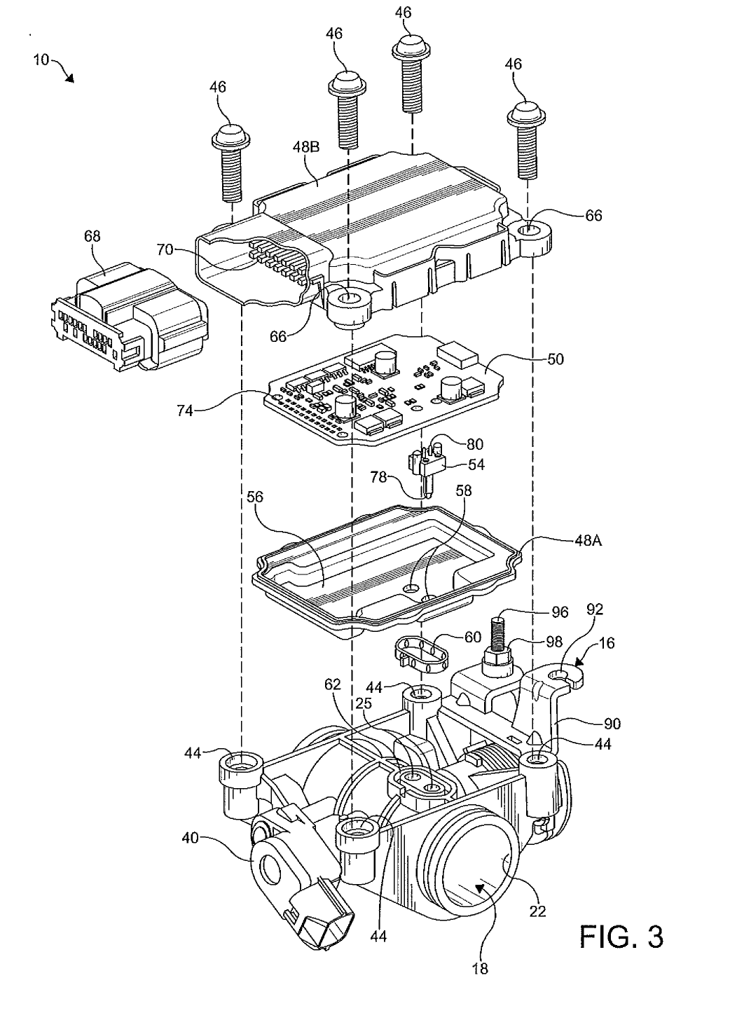

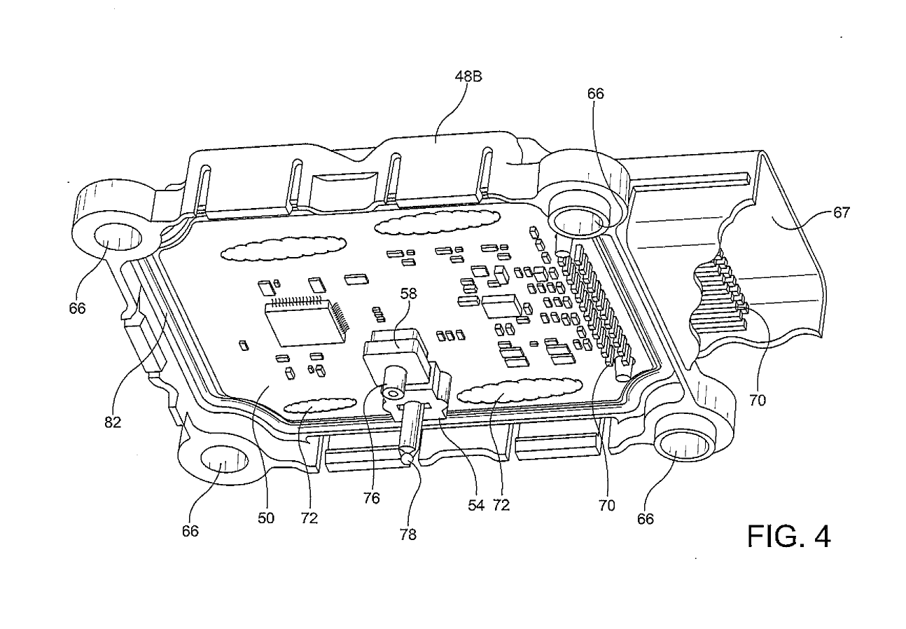

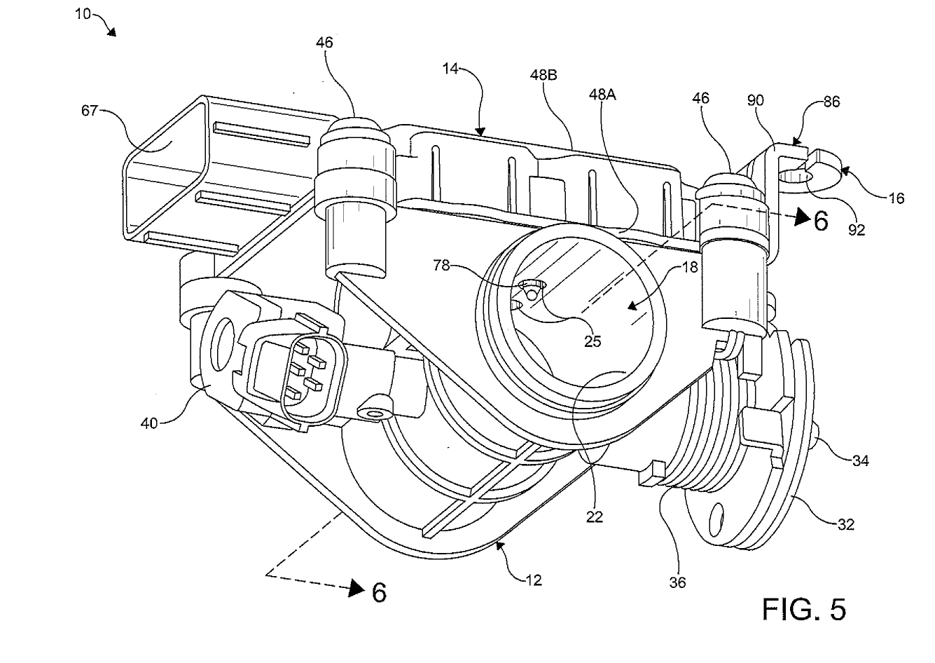

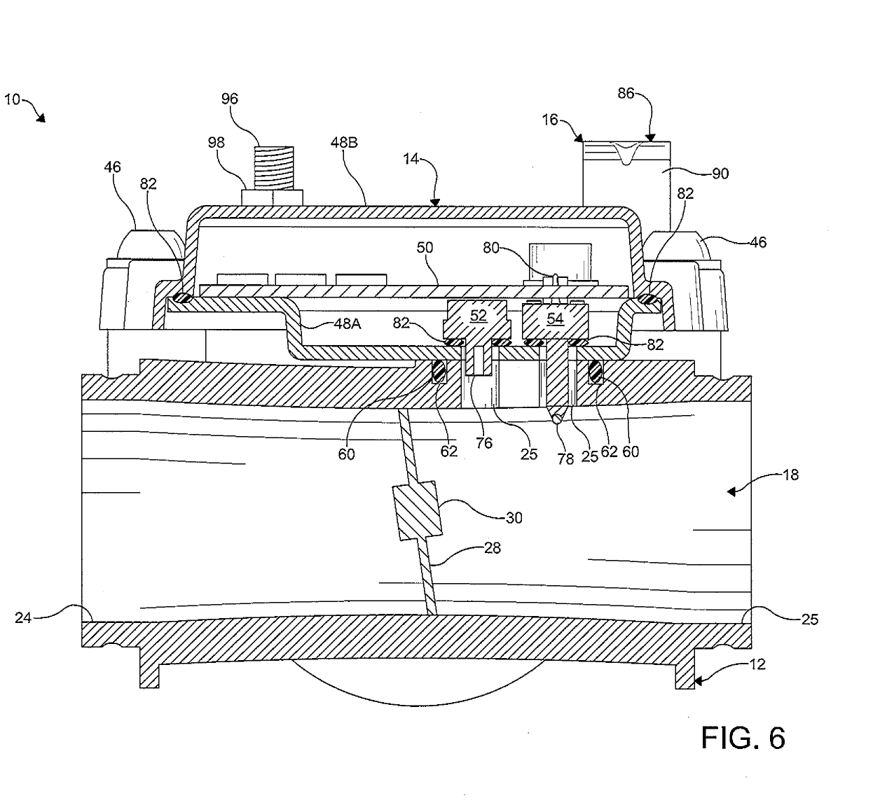

FIGS. 1-6, illustrate a throttle body assembly 10 for an internal combustion engine (not shown) according to an embodiment of the present invention. As shown, the throttle body assembly 10 includes a throttle body 12, an electronic control unit (ECU) 14, and a throttle bracket 16.

The throttle body 12 is typically a mechanical throttle body formed from plastic (e.g. injection molded). However, the throttle body 12 can be formed from other materials using other forming processes, as appreciated by one skilled in the art. The throttle body 12 includes a first passage 18 formed therethrough along a first axis A-A and a second passage 20 formed therethrough along a second axis B-B. As a non-limiting example, the first axis A-A is orthogonal to the second axis B-B.

The first passage 18 includes an inlet 22 which may be connected by a hose to an air filter (not shown) and an outlet 24 connected by another hose to an intake manifold (not shown) of an internal combustion engine. The first passage 18 also includes a plurality of first sensor apertures 25 or bores formed in a wall defining the first passage 18.

A throttle valve 26 is disposed at an intersection of the first passage 18 and the second passage 20 to control an air flow rate through the first passage 18 of the throttle body 12 and into the engine. As shown, the throttle valve 26 is a butterfly valve including a pivoting disc 28 or plate engaged rigidly to a rotating throttle shaft 30 disposed in the second passage 20 and along the second axis B-B. The shaft 30 extends axially along axis B-B through the second passage 20 and laterally across the first passage 18. The shaft 30 is typically actuated by a mechanical linkage (not shown) or a Bowden wire connected to a cam 32 or lever arm attached at a first end 34 to the shaft 30 to rotate the shaft 30, thus opening and closing the throttle valve 26 in the first passage 18.

As a non-limiting example, a return spring 36 is biased against the cam 32 and a portion of the throttle body 12 (or other static structure relative to the cam 32) to provide a return force to close the throttle valve 26, as appreciated by one skilled in the art.

As a further non-limiting example, a plurality of seals 38 (e.g. FKM elastomer) is circumferentially disposed around the shaft 30 to effectively seal the second passage 20 while the shaft 30 is disposed therein.

In certain embodiments, a throttle position sensor 40 (TPS) is coupled to the shaft 30 at a second end 42 thereof to measure a position and rotation of the shaft 30, and thereby an open/closed state of the throttle valve 26. It is understood that the throttle position sensor 40 can be positioned in various locations to measure a rotation of the shaft 30. It is further understood that other sensors, sensing means, and methods can be used to measure a position and rotation of the shaft 30 or overall state of the throttle valve 26.

In the embodiment shown, a plurality of fastener apertures 44 is formed in the throttle body 12. As a non-limiting example, the fastener apertures 44 are configured to receive a plurality of thread-forming fasteners 46. As a further non-limiting example, the fastener apertures 44 are pre-threaded to receive a threaded fastener. Although the fastener apertures 44 can be formed in/on any portion of the throttle body 12, favorable results have been achieved by generally symmetrically positioning the fastener apertures 44 adjacent a peripheral edge of the throttle body 12. It is understood that the fastener apertures 44 can include poka-yoke features for locating the fasteners 46 with the fastener apertures 44.

The ECU 14 includes a housing 48 that is releasable coupled to the throttle body 12, the housing 48 substantially enclosing at least a circuit board 50, a pressure sensor 52, and a temperature sensor 54. As a non-limiting example, the housing 48 is formed from a glass-filled polybutylene terephthalate (PBT). However, other materials can be used.

A lower portion 48A of the housing 48 is disposed adjacent a surface of the throttle body 12. As a non-limiting example, the lower portion 48A of the housing 48 is a heat sink plate formed from a material (e.g. metal) having desirable thermal conductivity. As a further non-limiting example, the lower portion 48A of the housing 48 includes a recessed portion 56 to receive the circuit board 50 and/or components mounted on the circuit board 50. The lower portion 48A of the housing 48 further includes a plurality of second sensor apertures 58 formed therethrough, wherein each of the second sensor apertures 58 is substantially aligned with one of first sensor apertures 25 formed in the wall defining the first passage 18. In certain embodiments, a gasket 60 is disposed between the lower portion 48A of the housing 48 and the throttle body 12 to effectively seal a juncture of the first sensor apertures 25 and the second sensor apertures 58. As a non-limiting example, the gasket 60 is a “press-in-place” gasket having a generally annular shape. As a further non-limiting example, a channel 62 can be formed in at least one of the throttle body 12 and the lower portion 48A of the housing 48 to receive the gasket 60 therein and maintain a position of the gasket 60 relative to the sensor apertures 25, 58.

An upper portion 48B of the housing 48 is coupled to the throttle body 12 and cooperates with the lower portion 48A of the housing 48 to substantially enclose at least the circuit board 50, the pressure sensor 52, and the temperature sensor 54. In certain embodiments, the upper portion 48B of the housing 48 includes a recessed area 64 to receive the circuit board 50 and the lower portion 48A of the housing 48 therein. As a non-limiting example, the upper portion 48B of the housing 48 includes a plurality of through-holes 66, each of the through-holes 66 aligned with the fastener apertures 44 formed in the throttle body 12 and configured to receive the fasteners 46 therethrough. Accordingly, when the upper portion 48B of the housing 48 is coupled to the throttle body 12, the lower portion 48A of the housing 48 is interposed between the upper portion 48B of the housing 48 and the throttle body 12 and secured in a substantially static position relative to the throttle body 12. It is understood that snap latches (not shown) can be included to couple the upper portion 48B of the housing 48 to at least the throttle body 12.

As a further non-limiting example, a receptacle 67 or port is formed along a peripheral edge of the upper portion 48B of the housing 48. The receptacle 67 is shown as a generally rectangular receptacle for receiving a harness connector 68 and mechanically securing the harness connector 68 to the upper portion 48B of the housing 48. Additionally, an electrically conductive connector 70 (e.g. press-fit connector, 24-pin connector assembly, pin biscuit, or the like) is formed with or coupled to the upper portion 48B of the housing 48 to provide electrical communication between the circuit board 50 and the harness connector 68. It is understood that other receptacles and coupling means can be formed in or on the upper portion 48B of the housing 48. It is further understood that other coupling means can be used to provide an electrical interconnection between the circuit board 50 enclosed by the housing 48 and a secondary device (not shown).

The circuit board 50 typically provides intercommunication between at least one of the pressure sensor 52 and the temperature sensor 54 and the electrically conductive connector 70. As a non-limiting example, the circuit board 50 includes a plurality of thermal vias 72 or thermal adhesive areas for managing heat transfer from the circuit board 50 and associated components to the lower portion 48A of the housing 48. As a further non-limiting example, the circuit board 50 includes a plurality of conductive apertures 74 formed therethrough to receive the electrically conductive connector 70 to establish electrical intercommunication between the circuit board 50 and the electrically conductive connector 70.

The pressure sensor 52 is mounted to the circuit board 50 and is positioned adjacent the lower portion 48A of the housing 48, wherein a sensing portion 76 of the pressure sensor 52 is disposed in or through at least one of the sensor apertures 25, 58 to sense a pressure in the first passage 18 formed in the throttle body 12. As a non-limiting example, the pressure sensor 52 is a manifold absolute pressure sensor. It is understood that the pressure sensor 52 can be a solder-less press-fit sensor for mounting to the circuit board 50.

The temperature sensor 54 is mounted to the circuit board 50 and is positioned adjacent the lower portion 48A of the housing 48, wherein a sensing portion 78 of the temperature sensor 54 is disposed in or through at least one of the sensor apertures 25, 58 to sense a temperature in the first passage 18 formed in the throttle body 12. As a non-limiting example, the temperature sensor 54 is an intake air temperature sensor. As a further non-limiting example, the temperature sensor 54 includes a pin 80 disposed opposite the sensing portion 78 thereof, wherein the pin 80 protrudes from the temperature sensor 54 and through the circuit board 50 for aligning and securing the temperature sensor 54 relative to the circuit board 50. It is understood that the temperature sensor 54 can be a solder-less press-fit sensor for mounting to the circuit board 50.

In certain embodiments, a sealant 82 is disposed around a periphery of the circuit board 50 and between the circuit board 50 and the upper portion 48B of the housing 48. The sealant 82 can also be disposed around each of the pressure sensor 52 and the temperature sensor 54 and between the sensors 52, 54 and the lower portion 48A of the housing 48. The sealant 82 can also be disposed adjacent a periphery of the lower portion 48A of the housing 48 and between the lower portion 48A and the upper portion 48B of the housing 48.

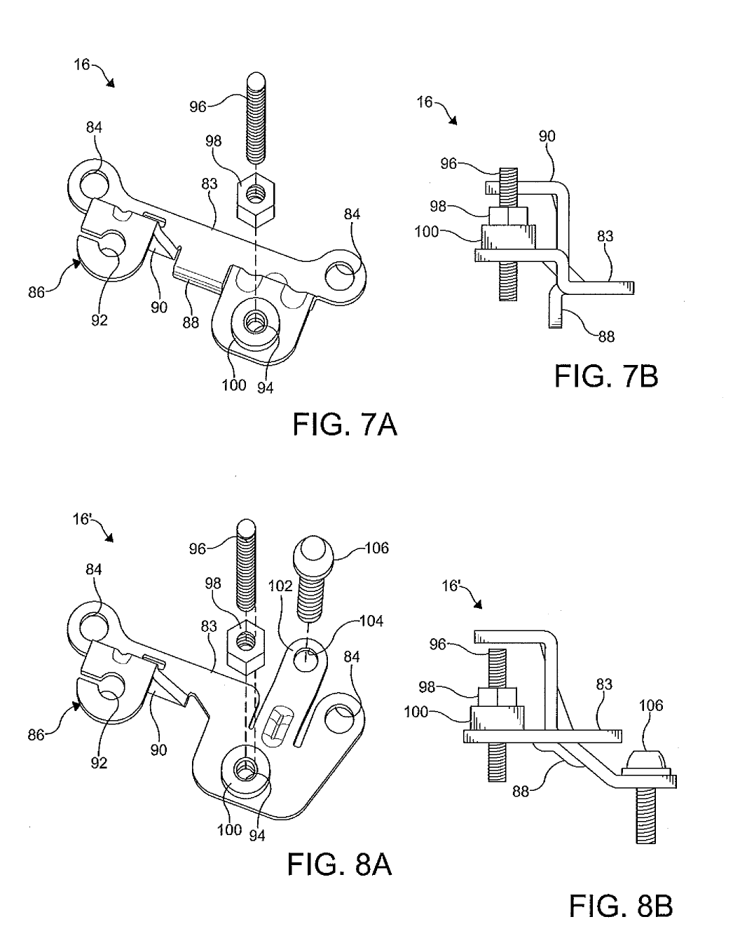

The throttle bracket 16, shown in FIGS. 7A-7B, can be disposed between a portion of the throttle body 12 and the ECU 14. As shown, the throttle bracket 16 includes a main body 83 having a plurality of mounting apertures 84 formed therein. The mounting apertures 84 are typically aligned with the fastener apertures 44 formed in the throttle body 12 and configured to receive the fasteners 46 therethrough to couple the throttle bracket 16 between the upper portion 48B of the housing 48 and the throttle body 12.

In the embodiment shown, the throttle bracket 16 also includes a cable guide 86 and a wide open throttle (WOT) stop 88. The cable guide 86 typically includes an armature 90 extending from the main body 83 of the throttle bracket 16 with an aperture 92 formed therein. It is understood that the mechanical linkage used to actuate the cam 32 is received through the aperture 92 formed in the armature 90 of the cable guide 86 to align and support the mechanical linkage.

The WOT stop 88 extends from the main body 83 of the throttle bracket 16 and is positioned to selectively abut a portion of the cam 32 to limit a rotation of the shaft 30 and thereby an actuation of the throttle valve 26, as understood by one skilled in the art.

In certain embodiments, an idle screw aperture 94 is formed in a portion of the main body 83 and receives an idle screw 96 therein. A locking nut 98 is circumferentially disposed around the idle screw 96 and can be positioned relative to the main body 83 of the throttle bracket 16 to adjust a position of the idle screw 16. As a non-limiting example, an idle screw flange 100 is disposed adjacent the idle screw aperture 94 and receives the idle screw 96 therethrough. Accordingly, the locking nut 98 disposed around the idle screw 96 abuts the idle screw flange 100 to maintain a position of the idle screw 96.

FIGS. 8A-8B illustrate a throttle bracket 16′ similar to the throttle bracket 16, except as described herein below. As shown, the throttle bracket 16′ includes a support armature 102 extending from the main body 83. An anchor aperture 104 is formed adjacent an end of the support armature 102 and is configure to receive a fastener 106 therein to secure the throttle bracket 16′ to the throttle body 12 without relying on the fasteners 46. As a non-limiting example, the throttle body 12 can include an aperture or receptacle (not shown) for receiving and securing the fastener 106. Accordingly, the fasteners 46 can be removed from the fastener apertures 44 and the ECU 14 can be separated from the throttle body 12 without disrupting a position of the throttle bracket 16′ relative to the throttle body 12. However, other means of coupling the throttle bracket 16′ to the throttle body 12 can be used. As a further non-limiting example, the WOT stop 88 can be formed on the support armature 102.

In operation, the throttle valve 26 is operated in a conventional manner to control a fluid flow rate through the first passage 18. The pressure sensor 52 and the temperature sensor 54 are positioned to measure a pressure and temperature in the first passage 18. The measured pressure and temperature are received as a signal by the circuit board 50 and subsequently analyzed to control various functions related to a fuel rate, a fuel mixture, a spark, and the like, in response to at least the measured pressure and temperature.

In certain embodiments, the ECU 14 controls numerous functions via an internal software instruction which can apply a fuel grid map, matrix or look up table in response to the sensed actual position of the throttle valve 26 versus engine rpm and crankshaft angular position. The internal software instruction can be leveraged to select a precise moment to open, and determine the opening duration of a fuel injector (not shown) which preferably injects pressurized fuel into the first passage 18 of the throttle body 12 for mixing with air and flowing the fuel-and-air mixture into a piston cylinder (not shown) of the engine.

The throttle body assembly 10 integrates the throttle body 12, the ECU 14, and the sensors 52, 54 in a configuration to reduce an overall package space. For example, the ECU 14 and the throttle body 12 cooperate to clamp and retain the throttle bracket 16 in a substantially static position, while minimizing a requirement for separate fastening means. The throttle body 12 and at least a portion of the housing 48 of the ECU 14 can be formed from a plastic or similar material to minimize cost and manufacturing lead times, thereby maximizing a producibility in emerging markets. The housing 48 of the ECU 14 can be removed from contact with the throttle body 12 without dismantling the components of the throttle valve 26 and the throttle body 12. Accordingly, each of the throttle body 12, the ECU 14, and the throttle valve 26 can be independently serviced.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An electronic control assembly for a throttle body, the electronic control assembly comprising:
a lower housing portion having a plurality of apertures formed therethrough;
a circuit board disposed adjacent at least a portion of the lower housing portion;
a pressure sensor disposed adjacent the lower housing portion and electrically coupled to the circuit board, wherein a sensing portion of the pressure sensor extends into a first one of the apertures formed in the lower housing portion;
a temperature sensor disposed adjacent the lower housing portion and electrically coupled to the circuit board, wherein a sensing portion of the temperature sensor extends into a second one of the apertures formed in the lower housing portion; and
an upper housing portion coupled to the throttle body and cooperating with the lower housing portion to substantially enclose the circuit board, the pressure sensor, and the temperature sensor.

2. The electronic control assembly according to claim 1, wherein the lower housing portion includes a recessed region to receive the circuit board and at least a portion of the lower housing portion therein.

3. The electronic control assembly according to claim 1, wherein the lower housing portion is a heat sink plate formed from a metal.

4. The electronic control assembly according to claim 1, further comprising an electrically conductive connector formed in the upper housing portion and in electrical communication with the circuit board.

5. The electronic control assembly according to claim 4, wherein the upper housing includes a receptacle at least one of coupled to and formed adjacent a peripheral edge thereof, the receptacle shrouding at least a portion of the electrically conductive connector.

6. The electronic control assembly according to claim 4, wherein the electrically conductive connector includes a plurality of electrically conductive pins and the circuit board includes a plurality of apertures to receive the electrically conductive pins.

7. A throttle body assembly comprising:
a mechanical throttle body including a throttle valve disposed in a passage formed through the throttle body, wherein the throttle body includes a plurality of first apertures formed in a wall defining the passage;
a heatsink disposed adjacent a surface of the throttle body, the heatsink including a plurality of second apertures formed therethrough, wherein each of the second apertures is substantially aligned with one of the first apertures formed in the wall of the throttle body;
a circuit board disposed adjacent at least a portion of the heatsink;
a pressure sensor disposed adjacent the heatsink and electrically coupled to the circuit board, wherein a sensing portion of the pressure sensor extends into a first one of the second apertures formed in the heatsink to sense a pressure in the passage of the throttle body;
a temperature sensor disposed adjacent the heatsink and electrically coupled to the circuit board, wherein a sensing portion of the temperature sensor extends into a second one of the second apertures formed in the heatsink to sense a temperature in the passage of the throttle body; and
a housing portion coupled to the throttle body and cooperating with the heat sink to substantially enclose the circuit board, wherein the housing portion secures the heatsink in a substantially static position relative to the throttle body.

8. The throttle body assembly according to claim 7, wherein the heatsink includes a recessed region to receive the circuit board and at least a portion of the heatsink therein.

9. The throttle body assembly according to claim 7, further comprising an electrically conductive connector formed in the housing portion and in electrical communication with the circuit board.

10. The throttle body assembly according to claim 9, wherein the housing portion includes a receptacle at least one of coupled to and formed adjacent a peripheral edge thereof, the receptacle shrouding at least a portion of the electrically conductive connector.

11. The electronic control assembly according to claim 9, wherein the electrically conductive connector includes a plurality of electrically conductive pins and the circuit board includes a plurality of apertures to receive the electrically conductive pins.

12. The throttle body assembly according to claim 7, further comprising a gasket disposed between the heatsink and the throttle body.

13. The throttle body assembly according to claim 12, wherein at least one of the heatsink and the throttle body includes a channel formed therein to receive the gasket and secure the gasket in a substantially static position relative to the at least one of the heatsink and the throttle body.

14. The throttle body assembly according to claim 7, further comprising a throttle bracket coupled to the throttle body, a portion of the throttle bracket disposed between the housing portion and the throttle body.

15. The throttle body assembly according to claim 14, wherein the throttle bracket includes a main body having a cable guide formed therein and a wide open throttle stop protruding therefrom.

16. The throttle body assembly according to claim 14, further comprising an idle screw extending through an aperture formed in the throttle bracket and a nut disposed adjacent the aperture formed in the throttle bracket and circumferentially disposed around the idle screw to maintain a pre-determined position of the idle screw relative to the throttle bracket.

17. A throttle body assembly comprising:
a mechanical throttle body including a first passage formed therethrough along a first axis of the throttle body and a second passage formed therethrough along a second axis, wherein the throttle body includes a plurality of sensor apertures formed in a wall defining the first passage;
a throttle valve disposed in the first passage formed through the throttle body;
a shaft disposed in the second passage formed through the throttle body, the shaft coupled to the throttle valve, wherein an actuation of the shaft controls a position of the throttle valve and a flow of fluid through the first passage of the throttle body;
a lower housing portion disposed adjacent a surface of the throttle body, the lower housing portion including a plurality of second apertures formed therethrough, wherein each of the second apertures is substantially aligned with one of the first apertures formed in the wall of the throttle body;
a circuit board disposed adjacent at least a portion of the lower housing portion;
a pressure sensor disposed adjacent the lower housing portion and electrically coupled to the circuit board, wherein a sensing portion of the pressure sensor extends into a first one of the second apertures formed in the lower housing portion to sense a pressure in the passage of the throttle body;
a temperature sensor disposed adjacent the lower housing portion and electrically coupled to the circuit board, wherein a sensing portion of the temperature sensor extends into a second one of the second apertures formed in the lower housing portion to sense a temperature in the passage of the throttle body; and
an upper housing portion coupled to the throttle body and cooperating with the lower housing portion to substantially enclose the circuit board, wherein the upper housing portion secures the lower housing portion in a substantially static position relative to the throttle body.

18. The throttle body assembly according to claim 17, further comprising a gasket disposed between the lower housing portion and the throttle body.

19. The throttle body assembly according to claim 17, further comprising a throttle bracket coupled to the throttle body, a portion of the throttle bracket disposed between the upper housing portion and the throttle body.

20. The throttle body assembly according to claim 17, wherein at least one of the pressure sensor and the temperature sensor extends along a plane that is substantially orthogonal to the second axis.
